(19) United States
(12) Patent Application Publication
(10) Pub. No.: US 2010/0121679 A1
(43) Pub. Date: May 13, 2010

(54) SYSTEM AND METHOD FOR REPRESENTATIVE ALLOCATION AND PRICING OF IMPRESSION SEGMENTS OF ONLINE ADVERTISEMENT IMPRESSIONS FOR ADVERTISING CAMPAIGNS

(75) Inventor: Randolph Preston McAfee, San Marino, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/270,727

(22) Filed: Nov. 13, 2008

(51) Int. Cl. G06Q 30/00; G06Q 10/00

(52) U.S. Cl. 705/10; 705/400; 705/14.73

(57) ABSTRACT

An improved system and method for representative allocation and pricing of impression segments of online advertisement impressions for advertising campaigns is provided. An inventory of online advertisement impressions may be grouped in impression segments according to attributes of the advertisement impressions and advertising campaigns for impressions targeting specific attributes may be received. A representative number of advertisement impressions from the impression segments may be determined for allocation to the advertising campaigns by maximizing the prices of the impression segments for each of the values of the advertising campaigns. The representative number of advertisement impressions from the impression segments may be allocated for the advertising campaigns, and the price of each of the advertising campaigns may be output for the allocated advertisement impressions.

### FIELD OF THE INVENTION

The invention relates generally to computer systems, and more particularly to an improved system and method for representative allocation and pricing of impression segments of online advertisement impressions for advertising campaigns.

### BACKGROUND OF THE INVENTION

Traditionally, there are two common internet advertising market segments. One is the text advertisement segment, and the other is the banner segment. Text advertisements are generally segments of text that may be linked to the advertiser's web site via a hypertext link. The text advertisement business is mainly conducted through sponsored search auction and content match technologies. Content matching is a widely used mechanism for selling online advertising by matching advertisements to content published on the Internet. Each time a user requests published content, advertising space may be allocated within the content served in response to the user's request. For instance, page content may be aggregated into keywords, and advertisements may be matched to content using the highest payment offered by an advertiser for the keywords representing the content.

For the banner advertising segment, behavioral targeting technology has been used, where both users and advertisements are mapped into categories, and then advertisements with the highest payments offered by an advertisers that are in the same categories with a user will be served to that user. Unfortunately, the categories may be defined by marketing personnel relying on their experience, rather than by the interests of the users. Moreover, the categories may be defined in a hierarchy that may focus on vertical areas such as travel or shopping, and thus may unnecessarily restrict selection of an advertisement within a vertical, instead of considering the broader interests of the users and a representative sample of display properties for advertisers.

What is needed is a way to allocate and price advertisements that provide a representative sample of display properties for advertisers and take into account the value of the unused inventory. Such a system and method should consider users' experience and interests to provide more relevant advertisements and should provide a representative sample of display properties for advertisers.

### SUMMARY OF THE INVENTION

The present invention provides a system and method for representative allocation and pricing of impression segments of online advertisement impressions for advertising campaigns. An allocation and pricing engine may be provided that determines a representative number of advertisement impressions from impression segments eligible to satisfy advertising campaigns by maximizing the prices of the impression segments for each of the values of the advertising campaigns. The allocation and pricing engine may be operably coupled to an inventory evaluator that identifies impression segments that satisfy targeting attributes of an advertising campaign. The allocation and pricing engine may also be operably coupled to a proportional inventory allocator that may allocate the representative number of advertisement impressions from the impression segments for the advertising campaigns. In general, such an allocation of advertisement impressions that is representative of eligible impression segments values diversification and may be optimized to derive market pricing of advertisement impression segments.

An inventory of online advertisement impressions may be grouped in impression segments according to attributes of the advertisement impressions and advertising campaigns for impressions targeting specific attributes may be received. A historical value previously paid may be obtained for each of the impression segments of the inventory of online advertisement impressions and an average price may be computed for each of the advertising campaigns. A representative number of advertisement impressions from the impression segments may be determined for allocation to the advertising campaigns by maximizing the prices of the impression segments for each of the values of the advertising campaigns. The representative number of advertisement impressions from the impression segments may be allocated for the advertising campaigns, and the price of each of the advertising campaigns may be output for the allocated advertisement impressions.

The present invention may be used by many applications to allocate and price impression segments of online advertisement impressions for advertising campaigns. For example, online banner advertising applications may use the present invention to allocate and price online advertisement impressions that satisfy advertising campaigns. Or online content-match advertising applications may use the present invention to allocate and price online advertisement impressions for available advertising space displayed with content requested by a user. Similarly, advertising applications for email may use the present invention to allocate and price online advertisement impressions for available advertising space displayed with a message from an inbox requested by a user. For any of these online advertising applications, advertisement impressions allocated from impression segments may be priced using the present invention to satisfy advertising campaigns.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for representative allocation and pricing of impression segments of online advertisement impressions for advertising campaigns, in accordance with an aspect of the present invention;

FIG. 3 presents a flowchart generally representing the steps undertaken in one embodiment for representative allocation and pricing of impression segments of online advertisement impressions for advertising campaigns, in accordance with an aspect of the present invention; and

FIG. 4 is a flowchart generally representing the steps undertaken in one embodiment for representative allocation and pricing of impression segments of online advertisement impressions by minimizing a squared distance of an allocation of advertisements that maximizes the value of impression segments from a proportional allocation of advertisements for each campaign, in accordance with an aspect of the present invention.

### DETAILED DESCRIPTION

### Exemplary Operating Environment

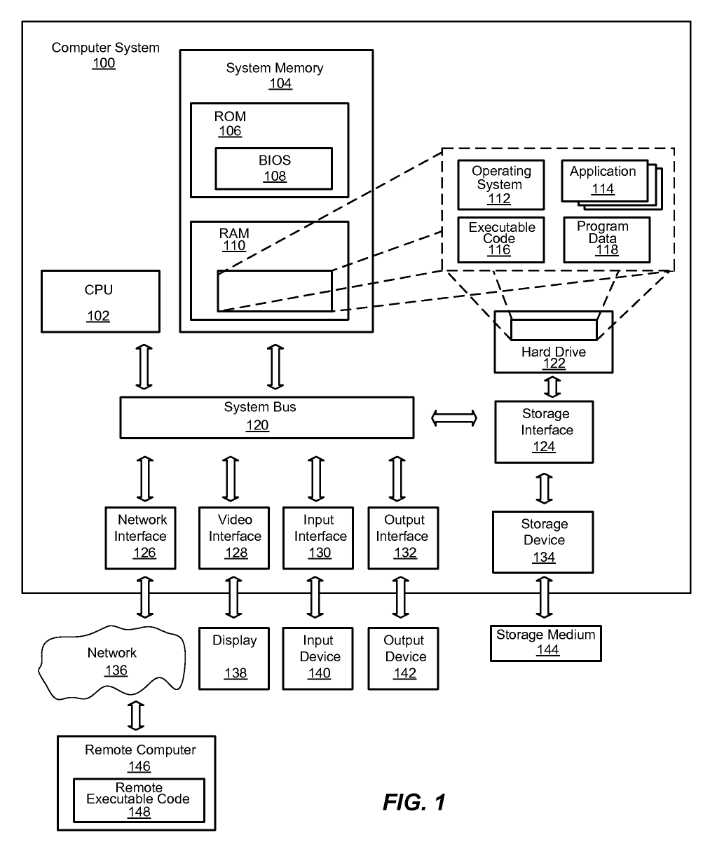

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Representative Allocation and Pricing of Impression Segments of Online Advertisement Impressions for Advertising Campaigns

The present invention is generally directed towards a system and method for representative allocation and pricing of impression segments of online advertisement impressions for advertising campaigns. An inventory of online advertisement impressions may be grouped by attributes into impression segments and advertising campaigns may be received for placement of advertisements on display properties. A representative allocation and pricing of impression segments may be optimized by minimizing a squared distance of an allocation of advertisements that maximizes value of impression segments from a proportional allocation of advertisements for each campaign. The representative allocation and pricing of impression segments may then be output for the advertising campaigns.

As will be seen, the present invention may be used by many applications to allocate and price impression segments of online advertisement impressions for advertising campaigns. As will be understood, the various block diagrams, flow charts and scenarios described herein are only examples, and there are many other scenarios to which the present invention will apply.

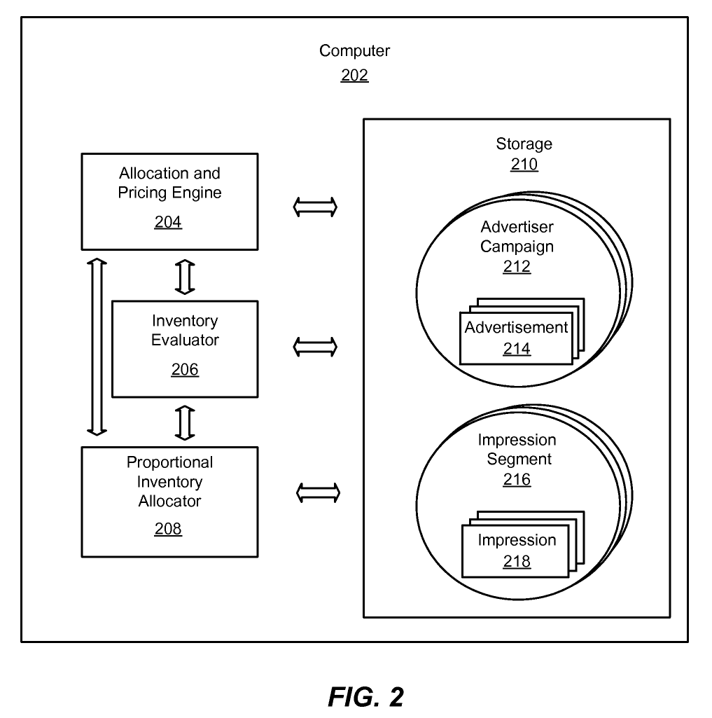

Turning to FIG. 2 of the drawings, there is shown a block diagram generally representing an exemplary architecture of system components for representative allocation and pricing of impression segments of online advertisement impressions for advertising campaigns. Those skilled in the art will appreciate that the functionality implemented within the blocks illustrated in the diagram may be implemented as separate components or the functionality of several or all of the blocks may be implemented within a single component. For example, the functionality of the inventory evaluator 206 may be implemented as a component within the allocation and pricing engine 204. Or the functionality of the inventory evaluator 208 may be implemented as a separate component from the allocation and pricing engine 204 as shown. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include an allocation and pricing engine 204, an inventory evaluator 206 and a proportional inventory allocator 208, each operably coupled to storage 210. The storage 210 may be any type of computer-readable storage media and may store advertiser campaigns 212 of advertisements 214. The storage 210 may also store impression segments 216 of advertisement impressions 218. Each of the advertisement campaigns may specify targeting attributes, and each impression segment may represent a group of advertisement impressions with common attributes from an inventory of online advertisement impressions.

The allocation and pricing engine 204 may allocate a representative sample of advertisement impressions 218 from impression segments 216 to satisfy advertiser campaigns 212 and may price the impressions 218 allocated to the advertiser campaigns 212. The allocation and pricing engine 204 may be operably coupled to an inventory evaluator 206 that may evaluate attributes of impression segments 216 and identify eligible impression segments 216 with advertisement impressions 218 that may satisfy targeting attributes of an advertiser campaign 212. The allocation and pricing engine 204 may also be operably coupled to a proportional inventory allocator 208 that may allocate a proportional number of advertisement impressions 218 as a representative sample from impression segments 216 eligible to satisfy advertisement campaigns 212. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

There may be many applications which may use the present invention to allocate and price impression segments of online advertisement impressions for advertising campaigns. For example, online banner advertising applications may use the present invention to allocate and price online advertisement impressions that satisfy advertising campaigns. Or online content-match advertising applications may use the present invention to allocate and price online advertisement impressions for available advertising space displayed with content requested by a user. Similarly, advertising applications for email may use the present invention to allocate and price online advertisement impressions for available advertising space displayed with a message from an inbox requested by a user. For any of these online advertising applications, advertisement impressions may be allocated and priced using the present invention to satisfy advertising campaigns.

In general, the inventory of impressions may be grouped and organized into impression segments by a set of attributes. A set of attributes may be any combination of one or more attributes associated with web page display properties, with web browser properties, with one or more users including demographics, online behavior, and so forth. Each impression segment may represent a disjoint set of attributes. For example, the set of attributes for an impression segment may include males between the ages of 20 and 30 living in the U.S. While each of the impression segments may represent a disjoint set of attributes, an inventory impression may belong to two or more impression segments. For instance, advertisement impressions in an impression segment that includes an attribute of “male” may also occur in another impression segment that includes an attribute of “living in the U.S.”

An Internet advertising service may receive numerous requests from advertisers to purchase impressions for advertising campaigns. Each of these requests may identify a specific number of impressions that are desired that satisfy a particular set of attributes. For instance, an advertiser may request that the Internet advertising service provide a million impressions targeted to males. An Internet advertising service has a number of options available to it to satisfy such a request, since there may be a number of disjoint impression segments that include the attribute of “male.” For example, the males may be living in the U.S. or outside the U.S., as well as within various age ranges. As a result, there are a number of different ways that the Internet advertising service may satisfy this request from the different disjoint impression segments that include the attribute of “male.”

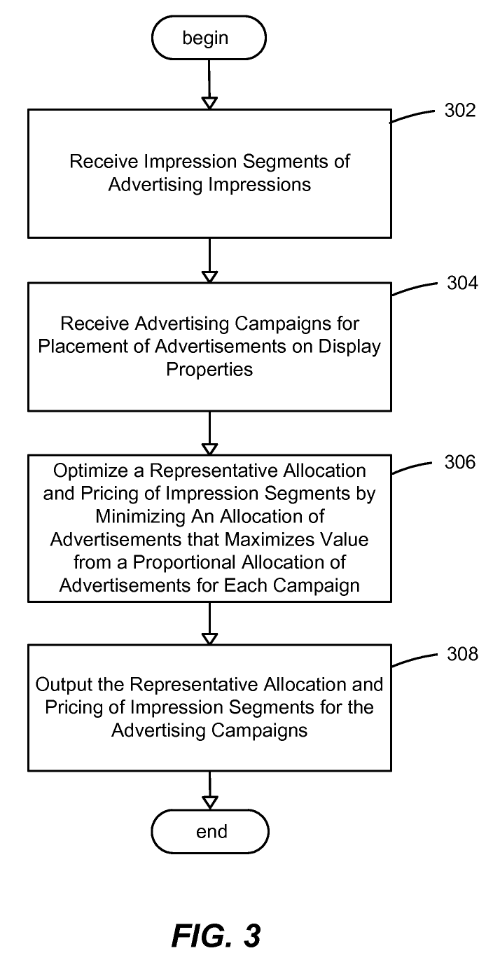

FIG. 3 presents a flowchart generally representing the steps undertaken in one embodiment for representative allocation and pricing of impression segments of online advertisement impressions for advertising campaigns. At step 302, impression segments of online advertising impressions may be received. In an embodiment, the advertisement impressions may be grouped by attributes into impression segments. For instance, the impression attributes may include web page attributes, user attributes, web browser attributes and so forth. At step 304, advertising campaigns may be received for placement of advertisements on display properties. An advertising campaign may represent one or more requests for placement of advertisement impressions targeting specific attributes on display advertising properties. As used herein, a display advertising property or display property may mean a collection of related web pages that may have advertising space allocated for displaying advertisements. At step 306, a representative allocation and pricing of impression segments may be optimized by minimizing a squared distance of an allocation of advertisements that maximizes value of impression segments from a proportional allocation of advertisements for each campaign. And the representative allocation and pricing of impression segments may be output at step 308 for the advertising campaigns.

Consider the indices of the impression segments to be denoted by i=1, . . . ,I, xᵢ to denote the volume of impression segment i. Also consider rᵢ to denote the reference price for impressions segment i. Next consider the indices of the requested campaigns to be denoted by j=1, . . . ,J. Consider, Bⱼ to denote the set of impression segments that can be used to satisfy the demand of campaign j, and yᵢⱼ to denote the amount of bucket i that will go toward campaign j, and Yⱼ to denote the guaranteed number of impressions for campaign j such that

$${Y}_{j} = {\sum }_{i ∈ {B}_{j}} {y}_{ij} .$$

The value of campaign j may be denoted by Vⱼ.

An allocation and pricing of impression segments that may supply a representative sample of impressions from eligible impression segments for requested campaigns may be optimized for an Internet advertising service by minimizing the squared distance of an allocation of advertisements from a proportional allocation of advertisements for each campaign.

It is desirable to weight the squared deviations by

$$\frac{{\sum }_{k ∈ {B}_{j}} {x}_{k}}{{x}_{i}} ,$$

to make the solution independent of impression segment division and by Vⱼ to reflect potentially differential campaign weighting. Thus the objective function used to minimize the squared distance of an allocation of advertisements from a proportional allocation of advertisements for each campaign may be in an embodiment

$$min \frac{1}{2} {\sum }_{j} {V}_{j } {\sum }_{i ∈ {B}_{j}} \frac{{\sum }_{k ∈ {B}_{j}} {x}_{k}}{{x}_{i}} {( \frac{{x}_{i}}{{\sum }_{k ∈ {B}_{j}} {x}_{k}} - \frac{{y}_{ij}}{{Y}_{j}} )}^{2} .$$

There may be three kinds of constraints for such an allocation. First, there must be an adequate number of impressions in each impression segment for the allocation to be feasible. Mathematically, this requires

$${x}_{i} \geq {\sum }_{j \vert i ∈ {B}_{j}} {y}_{ij} ,$$

for every bucket i. Second, each campaign must meet its guarantee, requiring

$${Y}_{j} = {\sum }_{i ∈ {B}_{j}} {y}_{ij}$$

for all campaigns j. In addition, quantities are non-negative, creating a constraint yᵢ^{j}≧0, for all i and j.

Consider pᵢ to denote the value of impression segment i. In an embodiment, pᵢ may be initialized to the historical price paid for advertisement impressions in impression segment i. To include the constraints in the objective function that there be an adequate number of impressions in each impression segment and that each campaign meets its guarantee, pᵢ may be a shadow value denoted by the Lagrangian multiplier on

$${x}_{i} \geq {\sum }_{j \vert i ∈ {B}_{j}} {y}_{ij}$$

and αⱼ be the multiplier on

$${Y}_{j} = {\sum }_{i ∈ {B}_{j}} {y}_{ij} .$$

The constraint that the quantities are non-negative may be handled manually. The objective function that includes the Lagrangian multiplier becomes the following equation:

$$min \frac{1}{2} {\sum }_{j} {V}_{j} {\sum }_{i ∈ {B}_{j}} \frac{{\sum }_{k ∈ {B}_{j}} {x}_{k}}{{x}_{i}} {( \frac{{x}_{i}}{{\sum }_{k ∈ {B}_{j}} {x}_{k}} - \frac{{y}_{ij}}{{Y}_{j}} )}^{2} + {\sum }_{i} {p}_{i} ( {\sum }_{j \vert i ∈ {B}_{j}} {y}_{ij} - {x}_{i} ) + {\sum }_{j} {α}_{j} ( {Y}_{j} - {\sum }_{i ∈ {B}_{j}} {y}_{ij} ) .$$

The first order conditions, for iεBⱼ, come in the form of

$$0 = - {V}_{j} ( \frac{{x}_{i}}{{\sum }_{k ∈ {B}_{j}} {x}_{k}} - \frac{{y}_{ij}}{{Y}_{j}} ) \frac{{\sum }_{k ∈ {B}_{j}} {x}_{k}}{{x}_{i}} + {p}_{i} - {α}_{j} , \\ or {y}_{ij} = 0 and \frac{\partial L}{\partial {y}_{ij}} \geq 0.$$

### Thus,

$$\frac{{y}_{ij}}{{Y}_{j}} = ( \frac{{x}_{i}}{{\sum }_{k ∈ {B}_{j}} {x}_{k}} ) ( 1 - \frac{{p}_{i} - {α}_{j}}{{V}_{j}} )$$

$$or {y}_{ij} = 0 and$$

$$0 \geq ( \frac{{x}_{i}}{{\sum }_{k ∈ {B}_{j}} {x}_{k}} ) ( 1 - \frac{{p}_{i} - {α}_{j}}{{V}_{j}} ) .$$

Considering Aⱼ={iεBⱼ|yᵢⱼ>0} and summing over iεAⱼ, the multiplier αⱼ may be obtained in the form of the equation,

$${α}^{j} = \frac{{\sum }_{k ∈ {B}_{j} \backslash {A}_{j}} {x}_{k} {V}_{j} + ( {\sum }_{i ∈ {A}_{j}} {x}_{i} {p}_{i} )}{{\sum }_{i ∈ {A}_{j}} {x}_{k}} .$$

Substituting the value of αⱼ into

$$\frac{{y}_{ij}}{{Y}_{j}} = ( \frac{{x}_{i}}{{\sum }_{k ∈ {B}_{j}} {x}_{k}} ) ( 1 - \frac{{p}_{i} - {α}_{j}}{{V}_{j}} )$$

or yᵢⱼ=0 and

$$0 \geq ( \frac{{x}_{i}}{{\sum }_{k ∈ {B}^{j}} {x}_{k}} ) ( 1 - \frac{{p}_{i} - {α}_{j}}{{V}_{j}} ) ,$$

the following equation for a proportional allocation of advertisements for each campaign from eligible impression segments is obtained:

$$\frac{{y}_{ij}}{{Y}_{j}} = \frac{1}{{V}^{j}} ( \frac{{x}_{i}}{{\sum }_{k ∈ {B}^{j}} {x}_{k}} ) ( {V}^{j} \frac{{\sum }_{k ∈ {B}^{j}} {x}_{k}}{{\sum }_{i ∈ {A}^{j}} {x}_{k}} - {p}_{i} + \frac{{\sum }_{i ∈ {A}^{j}} {x}_{i} {p}_{i}}{{\sum }_{i ∈ {A}^{j}} {x}_{k}} ) .$$

There may be a critical level, denoted by p*ⱼ, that represents the maximum value of inventory for campaign j that is the price campaign j is willing to pay for impressions in inventory. Note that the critical level p*ⱼ occurs when yᵢⱼ=0, if and only if pᵢ≦p*ⱼ. From the equation

$$\frac{{y}_{ij}}{{Y}_{j}} = \frac{1}{{V}^{j}} ( \frac{{x}_{i}}{{\sum }_{k ∈ {B}^{j}} {x}_{k}} ) ( {V}^{j} \frac{{\sum }_{k ∈ {B}^{j}} {x}_{k}}{{\sum }_{i ∈ {A}^{j}} {x}_{k}} - {p}_{i} + \frac{{\sum }_{i ∈ {A}^{j}} {x}_{i} {p}_{i}}{{\sum }_{i ∈ {A}^{j}} {x}_{k}} ) ,$$

p*ⱼ must equal

$${V}_{j} \frac{{\sum }_{k ∈ {B}_{j}} {x}_{k}}{{\sum }_{i ∈ {A}_{j}} {x}_{k}} + \frac{{\sum }_{i ∈ {A}_{j}} {x}_{i} {p}_{i}}{{\sum }_{i ∈ {A}_{j}} {x}_{k}} = \frac{{V}_{j} {\sum }_{k ∈ {B}_{j}} {x}_{k} + {\sum }_{i ∈ {A}_{j}} {x}_{i} {p}_{i}}{{\sum }_{i ∈ {A}_{j}} {x}_{k}} ,$$

where

Aⱼ={iεBⱼ|yᵢⱼ>0}={iεBⱼ|pᵢ<p*ⱼ}.

Thus, an allocation for a proportional representation of advertisements for each campaign from eligible impression segments may be calculated by the following equation that considers the maximum value of the inventory for each campaign:

$$\frac{{y}_{ij}}{{Y}_{j}} = \frac{1}{{V}_{j}} ( \frac{{x}_{i}}{{\sum }_{k ∈ {B}_{j}} {x}_{k}} ) Max [ 0 , {p}_{j}^{*} - {p}_{i} ] .$$

Importantly, this solution delivers quantities as a function of prices. In the special case where all the quantities of campaign j are positive for all of the impression segments, consider

$${\overline{p}}_{j} = \frac{{\sum }_{k ∈ {B}_{j}} {p}_{k} {x}_{k}}{{\sum }_{k ∈ {B}_{j}} {x}_{k}} .$$

Then an allocation for a proportional representation of advertisements may be calculated by the following equation that considers the maximum value of the inventory for each campaign:

$${y}_{ij} = ( \frac{{x}_{i} {Y}_{j}}{{\sum }_{k ∈ {B}_{j}} {x}_{k}} ) ( 1 - \frac{{p}_{i} - {\overline{p}}_{j}}{{V}_{j}} ) = \frac{1}{{V}_{j}} ( \frac{{x}_{i} {Y}_{j}}{{\sum }_{k ∈ {B}_{j}} {x}_{k}} ) ( {V}_{j} + {\overline{p}}_{j} - {p}_{i} ) .$$

Given the special case where all of the impression segments are eligible impression segments, then either max pᵢ≦Vⱼ+ p̅ⱼ and the allocation and price of inventory may be calculated for each campaign

$$by {y}_{ij} = ( \frac{{x}_{i} {Y}_{j}}{{\sum }_{k ∈ {B}_{j}} {x}_{k}} ) ( 1 - \frac{{p}_{i} - {\overline{p}}_{j}}{{V}_{j}} ) = \frac{1}{{V}_{j}} ( \frac{{x}_{i} {Y}_{j}}{{\sum }_{k ∈ {B}_{j}} {x}_{k}} ) ( {V}_{j} + {\overline{p}}_{j} - {p}_{i} ) , \\ or {max}_{i ∈ {B}_{j}} {p}_{i} > {V}_{j} + {\overline{p}}_{j}$$

and the allocation and price of inventory may be calculated for each campaign by

$$\frac{{y}_{ij}}{{Y}_{j}} = \frac{1}{{V}_{j}} ( \frac{{x}_{i}}{{\sum }_{k ∈ {B}_{j}} {x}_{k}} ) Max [ 0 , {p}_{j}^{*} - {p}_{i} ]$$

with the largest set Aⱼ chosen for maximal representation.

A procedure for calculating each campaign by

$$\frac{{y}_{ij}}{{Y}_{j}} = \frac{1}{{V}_{j}} ( \frac{{x}_{i}}{{\sum }_{k ∈ {B}_{j}} {x}_{k}} ) Max [ 0 , {p}_{j}^{*} - {p}_{i} ]$$

is to rank-order the prices from highest to lowest pₘₐₓ≧ . . . ≧p₂≧p₁, and calculate the critical price p*ⱼ, for all of the campaigns from highest to lowest prices using the following equation:

$${p}_{hj}^{*} = \frac{{V}_{j} {\sum }_{k ∈ {B}_{j}} {x}_{k} + {\sum }_{s = 1}^{h} {x}_{s} {p}_{s}}{{\sum }_{s = 1}^{h} {x}_{s}}$$

until a highest h is found where pₕ≦pₕ*^{j}<pₕ₋₁. There must be one by hypothesis, since p₁<p₁*ⱼ and pₘₐₓ>pₘₐₓ*ⱼ. A representative number of impressions may be allocated from eligible impression segments to each campaign that maximizes the value of the campaigns, and it may be determined whether there is excess demand for impressions allocated from impression segments eligible for the campaigns. Given that excess demand may be proportional to

$${\sum }_{j} {B}_{i}^{j} {y}_{i}^{j} - {x}_{i} ,$$

excess demand may be either zero or excess demand may be negative and pᵢ=rᵢ. If there is excess demand or the price of impression segments is greater than the reserve price, then the procedure may reiterate until the price of impression segments is equal to their reserve price when there is no excess demand.

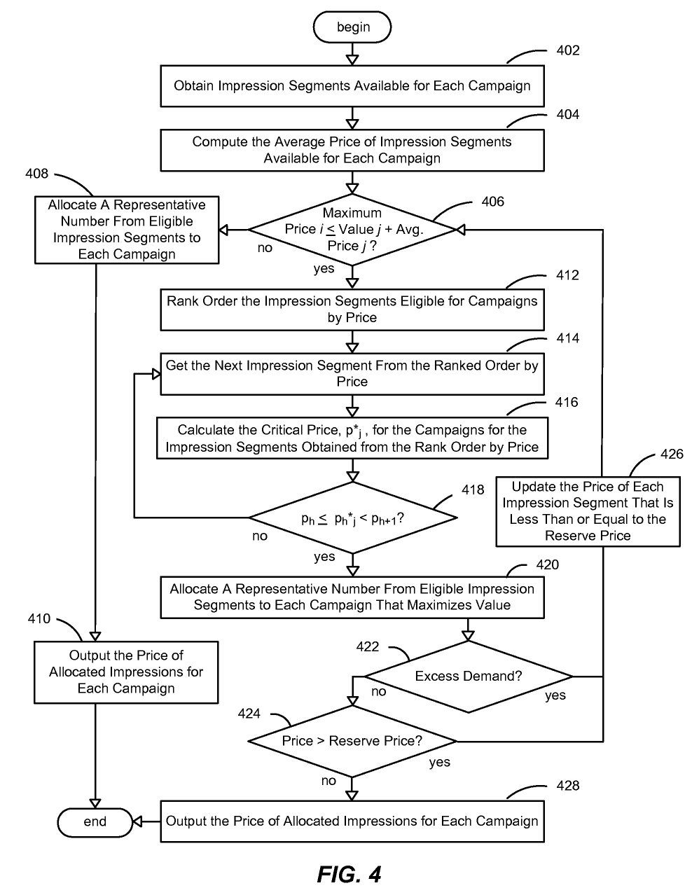

Accordingly, FIG. 4 presents a flowchart generally representing the steps undertaken in one embodiment for representative allocation and pricing of impression segments of online advertisement impressions by minimizing a squared distance of an allocation of advertisements that maximizes the value of impression segments from a proportional allocation of advertisements for each campaign. At step 402, the impression segments available for each campaign may be obtained. In an embodiment, the impression segments available to a campaign may be assigned by an inventory evaluator that identifies attributes of impression segments that match attributes for a campaign. At step 404, the average price of impression segments available for each campaign may be computed. For instance, the average price of impression segments available for each campaign may be computed by

$${\overline{p}}_{j} = \frac{{\sum }_{k ∈ {B}_{j}} {B}_{jk} {p}_{k}}{{\sum }_{k ∈ {B}_{j}} {B}_{jk}} .$$

At step 406, it may be determined whether the maximum price of the impression segments eligible for each campaign is less than or equal to the value of the campaign plus the average price of impression segments eligible for the campaign:

$${max}_{i ∈ {B}_{j}} {p}_{i} \leq {V}_{j} + {\overline{p}}_{j} .$$

If so, then a representative number of impressions may be allocated at step 408 from eligible impression segments to each campaign that maximizes the value of the campaigns. In an embodiment, the representative number of impressions may be allocated by the following equation that considers the maximum value of the inventory for each campaign

$${y}_{ij} = \frac{1}{{V}_{j}} ( \frac{{x}_{i} {Y}_{j}}{{\sum }_{k ∈ {B}_{j}} {x}_{k}} ) ( {V}_{j} + {\overline{p}}_{j} - {p}_{i} ) .$$

The price of the allocated impressions for each campaign may be output at step 410 and processing may be finished.

If it may be determined at step 406 that the maximum price of the impression segments eligible for a campaign is greater than the value of the campaign plus the average price of impression segments eligible for the campaign, then the impression segments eligible for the campaigns may be rank ordered by price at step 412.

Steps 414 to 418 may get each impression segment from the rank-order by price from highest to lowest pₘₐₓ≧ . . . ≧p₂≧p₁, and calculate the critical price p*ⱼ, for all of the campaigns from highest to lowest prices using the following equation:

$${p}_{hj}^{*} = \frac{{V}_{j} {\sum }_{k ∈ {B}_{j}} {x}_{k} + {\sum }_{s = 1}^{h} {x}_{s} {p}_{s}}{{\sum }_{s = 1}^{h} {x}_{s}}$$

until a highest h is found where pₕ≦pₕ*^{j}<pₕ₊₁.

At step 414 the next impression segment may be obtained from the rank order of impression segments by price in order to calculate the critical price, p*ⱼ, for all of the campaigns for the impression segments obtained from the rank order by price. At step 416, the critical price, p*ⱼ, may be calculated for all of the campaigns for the impression segments obtained from the rank order by price. In an embodiment, the critical price, p*ⱼ, for all of the campaigns may be calculated for the impression segments obtained from the rank order by price using the following equation:

$${p}_{hj}^{*} = \frac{{V}_{j} {\sum }_{k ∈ {B}_{j}} {x}_{k} + {\sum }_{s = 1}^{h} {x}_{s} {p}_{s}}{{\sum }_{s = 1}^{h} {x}_{s}} .$$

At step 418, it may be determined whether the critical price for the impression segment obtained at step 414 is greater than or equal to the price of the impression segment and less than the previous rank ordered impression segment obtained from the rank order such that pₕ≦pₕ*^{j}<pₕ₊₁. If so, then at step 420 a representative number of impressions may be allocated from eligible impression segments to each campaign that maximizes the value of the campaigns. In an embodiment, the representative number of impressions may be allocated by the following equation that considers the maximum value of the inventory for each campaign

$$\frac{{y}_{ij}}{{Y}_{j}} = \frac{1}{{V}_{j}} ( \frac{{x}_{i}}{{\sum }_{k ∈ {B}_{j}} {x}_{k}} ) Max [ 0 , {p}_{j}^{*} - {p}_{i} ] .$$

At step 422, it may be determined whether there is excess demand for impressions allocated from impression segments eligible for the campaigns. In an embodiment, excess demand for impressions allocated from the impression segments may be calculated by the equation,

$${\sum }_{j} {B}_{ij} {y}_{ij} - {x}_{i} > 0.$$

If not, then it may be determined at step 424 whether the price is greater than the reserve price for each impression segment such that pᵢ>rᵢ. If there is not excess demand and the price is not greater than the reserve price for each impression segment when there is excess demand, then the price of the allocated impressions for each campaign may be output at step 428 and processing may be finished. Otherwise, if it may be determined that there is excess demand at step 422, then the price for each impression segment that is less than or equal to the reserve price may be updated at step 426. In an embodiment, the price for each impression segment may be updated by the equation

$${p}_{i} = {\sum }_{j} {B}_{ij} {y}_{ij} - {x}_{i}$$

where pᵢ≦rᵢ. And processing may continue at step 406 where it may be determined whether the maximum price of the impression segments eligible for each campaign is less than or equal to the value of the campaign plus the average price of impression segments eligible for the campaign. And if it may be determined at step 424 that the price is greater than the reserve price for each impression segment when there is excess demand, then the price for each impression segment that is less than or equal to the reserve price may be updated at step 426. In an embodiment, the price for each impression segment may be updated by the equation

$${p}_{i} = {\sum }_{j} {B}_{ij} {y}_{ij} - {x}_{i}$$

where pᵢ≦rᵢ. And processing may continue at step 406 where it may be determined whether the maximum price of the impression segments eligible for each campaign is less than or equal to the value of the campaign plus the average price of impression segments eligible for the campaign.

Those skilled in the art will appreciate that the steps undertaken in the embodiment described in conjunction with FIG. 4 for representative allocation and pricing of impression segments of online advertisement impressions may be modified or additional steps may be added. For example, in the event that the last impression segment may be obtained from the rank order and it may be determined at step 414 that the critical price for the last impression segment obtained is not greater than or equal to the price of the impression segment and less than the previous rank ordered impression segment obtained from the rank order such that pₕ≦pₕ*^{j}<pₕ₊₁, then a representative number of impressions may be allocated in an embodiment from eligible impression segments to each campaign as done at step 420 that maximizes the value of the campaigns and the price of the allocated impressions may be output for each campaign as done at step 428.

Thus the present invention may optimize an allocation and pricing of impression segments that is representative of eligible impression segments available for each campaign and maximize the value of impression segments allocated for each campaign. Such an allocation of advertisement impressions that is representative of eligible impression segments values diversification and may be based upon pricing that equates supply and demand to derive market pricing of advertisement impression segments. Moreover, those skilled in the art will appreciate that the present invention may be deployed by advertising systems where targeting attributes are taken into consideration as well as by advertising system that do not consider targeting attributes. Moreover, eligible impression segments for each campaign may be defined by an independent set of attributes instead of demand attributes of an advertising campaign.

As can be seen from the foregoing detailed description, the present invention provides an improved system and method for representative allocation and pricing of impression segments of online advertisement impressions for advertising campaigns. Advertising campaigns for impressions targeting specific attributes may be received. A representative number of advertisement impressions from the impression segments may be determined for allocation to the advertising campaigns by maximizing the prices of the impression segments for each of the values of the advertising campaigns. The representative number of advertisement impressions from the impression segments may be allocated for the advertising campaigns, and the price of each of the advertising campaigns may be output for the allocated advertisement impressions. Advantageously, the system and method of the present invention may be generally applied by many online advertising applications for allocating impression segments of advertisements for advertising campaigns. As a result, the system and method provide significant advantages and benefits needed in contemporary computing, and more particularly in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for allocating and pricing online advertising, comprising:
an allocation and pricing engine that determines a representative number of advertisement impressions from a plurality of impression segments for a plurality of advertising campaigns by maximizing a plurality of prices of the plurality of impression segments for each of a plurality of values of the plurality of advertising campaigns;
a proportional inventory allocator operably coupled to the allocation and pricing engine that may allocate the representative number of advertisement impressions from the plurality of impression segments for the plurality of advertising campaigns that maximizes the plurality of prices of the plurality of impression segments for each of the plurality of values of the plurality of advertising campaigns; and
a storage operably coupled to the allocation and pricing engine that stores the plurality of impression segments and the plurality of advertising campaigns.

2. The system of claim 1 further comprising an inventory evaluator operably coupled to the allocation and pricing engine that identifies at least one impression segment from the plurality of impression segments with advertisement impressions that satisfy targeting attributes of an advertising campaign.

3. A computer-readable medium having computer-executable components comprising the system of claim 1.

4. A computer-implemented method for pricing online advertising, comprising:
receiving a plurality of impression segments of a plurality of advertisement impressions;
receiving a plurality of requests for a plurality of advertisement placements on a plurality of display properties for a plurality of advertising campaigns;
determining a representative number of advertisement impressions from the plurality of impression segments for the plurality of advertising campaigns by maximizing a plurality of prices of the plurality of impression segments for each of a plurality of values of the plurality of advertising campaigns;
allocating the representative number of advertisement impressions from the plurality of impression segments for the plurality of advertising campaigns; and
outputting a price of each of the plurality of advertising campaigns for the allocated advertisement impressions.

5. The method of claim 4 further comprising obtaining a value for each of the plurality of prices of the plurality of impression segments.

6. The method of claim 5 further comprising setting the value for each of the plurality of prices of the plurality of impression segments to a rate previously paid for each of the plurality of impression segments.

7. The method of claim 4 wherein determining the representative number of advertisement impressions from the plurality of impression segments for the plurality of advertising campaigns by maximizing the plurality of prices of the plurality of impression segments for each of the plurality of values of the plurality of advertising campaigns comprises minimizing a squared distance between an allocation from impression segments and a representative allocation from impression segments that maximizes the plurality of prices of the impression segments for each of the plurality of values of the plurality of advertising campaigns.

8. The method of claim 4 wherein determining the representative number of advertisement impressions from the plurality of impression segments for the plurality of advertising campaigns by maximizing the plurality of prices of the plurality of impression segments for each of the plurality of values of the plurality of advertising campaigns comprises computing an average price of each of the plurality of the impression segments available for each of the plurality of advertising campaigns.

9. The method of claim 8 further comprising determining whether a maximum price of an impression segment of the plurality of impression segments eligible for a campaign of the plurality of advertising campaigns is less than or equal to a value of the campaign plus an average price of the impression segment eligible for the campaign.

10. The method of claim 9 further comprising rank ordering the plurality of impression segments by the plurality of prices of the plurality of impression segments.

11. The method of claim 10 further comprising iteratively obtaining a price of an impression segment from the rank ordering and calculating a maximum value of the impression segments obtained from the rank ordering for each of the advertising campaigns until the maximum value is greater than or equal to the value of the impression segment and the maximum value is less than or equal to the value of an impression segment previously obtained in the rank ordering.

12. The method of claim 11 further comprising determining whether excess demand exists for the plurality of advertisement impressions allocated from the plurality of impression segments for the plurality of advertising campaigns.

13. The method of claim 12 further comprising determining that excess demand exists for the plurality of advertisement impressions allocated from the plurality of impression segments for the plurality of advertising campaigns and determining whether a maximum price of an impression segment of the plurality of impression segments eligible for a campaign of the plurality of advertising campaigns is less than or equal to a value of the campaign plus an average price of the impression segment eligible for the campaign.

14. The method of claim 13 further comprising rank ordering the plurality of impression segments by the plurality of prices of the plurality of impression segments.

15. The method of claim 14 further comprising iteratively obtaining a price of an impression segment from the rank ordering and calculating a maximum value of the impression segments obtained from the rank ordering for each of the advertising campaigns until the maximum value is greater than or equal to the impression segment.

16. A computer-readable medium having computer-executable instructions for performing the method of claim 4.

17. A computer system for pricing online advertising, comprising:
means for receiving a plurality of impression segments of a plurality of advertisement impressions;
means for receiving a plurality of requests for a plurality of advertisement placements on a plurality of display properties for a plurality of advertising campaigns;
means for determining a representative number of advertisement impressions from the plurality of impression segments for the plurality of advertising campaigns by maximizing a plurality of prices of the plurality of impression segments for each of a plurality of values of the plurality of advertising campaigns;
means for allocating the representative number of advertisement impressions from the plurality of impression segments for the plurality of advertising campaigns; and
means for outputting a price of each of the plurality of advertising campaigns for the allocated advertisement impressions.

18. The computer system of claim 17 further comprising means for obtaining a value for each of the plurality of prices of the plurality of impression segments.

19. The computer system of claim 17 wherein means for determining a representative number of advertisement impressions from the plurality of impression segments for the plurality of advertising campaigns by maximizing a plurality of prices of the plurality of impression segments for each of a plurality of values of the plurality of advertising campaigns comprises means for minimizing a squared distance between an allocation from impression segments and a representative allocation from impression segments that maximizes the plurality of prices of the impression segments for each of the plurality of values of the plurality of advertising campaigns.

20. The computer system of claim 19 further comprising means for determining whether excess demand exists for the plurality of advertisement impressions allocated from the plurality of impression segments for the plurality of advertising campaigns.
